(19) United States
(12) Patent Application Publication
(10) Pub. No.: US 2005/0102834 A1
(43) Pub. Date: May 19, 2005

(54) Single piece cam method for the production thereof and assembly of a camshaft

(76) Inventors: Peter Wiesner, Ludesch (AT); Peter Meusburger, Feldkirch (AT); Oskar Muller, Thurignerberg (AT)

Correspondence Address: Max Fogiel, 44 Maple Court, Highland Park, NJ, 08904, US

(21) Appl. No.: 10/507,984

(22) PCT Filed: Mar. 28, 2003
(86) PCT No.: PCT/EP03/03232

(30) Foreign Application Priority Data
Apr. 29, 2002 (DE) 102 19 195.6

(51) Int. Cl. B23P 19/02; B21K 1/12

(52) U.S. Cl. 29/888.1; 29/525; 74/53

(57) ABSTRACT

In order to significantly reduce the weight of a single-piece cam (2) of a built camshaft, the cam (2), seen from the semi-cross-sectional point of view, comprises a T-shaped cross section having a narrow bridge (4) that extends towards the center thereof and a wraparound top (5) which protrudes by approximately the same distance on both sides and has an approximately constant cross section. The inventive cam (2) is preferably produced by hot forging or cold forging a semifinished pipe or round plate. Preferably, a camshaft comprising a shaft and at least one cam (2) is assembled by providing the support axle with an enlargement in the joining area by means of rolls, rollers, or knurls, said enlargement being greater than the inner diameter of the cam (2), and by inserting the cam (2), resulting in a positive and/or non-positive connection between the support axle and the cam (2).

The present invention concerns a single-component cam and a method of manufacturing such a cam as well as a compound engine camshaft or valve-control camshaft manufactured therefrom.

Compound engine camshafts are composed of single-component cams fastened to a core by one of several means. Such shafts are easy to manufacture and light in weight and are accordingly increasingly in demand for motor-vehicle engines.

Single-component cams are almost always disk-shaped. German 3 738 809 C2 proposes further decreasing the weight by recessing the faces of the cams. Recessing, however, is complicated and expensive. Machining the recess requires complicated processing and wear on the bit. Still, even approaches like forging, extrusion, or sintering for example, that do not remove material also result in considerable wear. This strategy has accordingly not proved successful for decreasing the weight of cams for compound camshafts.

The aforesaid field of application, for engine camshafts, also extends to the manufacture of camshafts employed to control variable mechanical valve-drive mechanisms. The cams can in this case be provided with special contours.

The object of the present invention is to further decrease the weight of cams employed in compound engine or valve-control camshafts.

This object is attained in accordance with the present invention in cams and shafts of the aforesaid genera by the characteristics recited in the body of Claim 1. Claims 2 through 4 address practical alternative and advanced embodiments. Claim 15 addresses a method of manufacturing a cam like one of those addressed in Claims 1 through 14. Claim 16 addresses a method of assembling an engine camshaft or valve-control camshaft with cams like one of those addressed in Claims 1 through 14.

Cams in accordance with the present invention are not only lighter and simpler than the known single-component cams employed in this field, but also subject the bits to much less wear than at the state of the art.

Hot-forged or cold-forged cams with the characteristics described in Claims 1 through 14 also have considerably thinner rims than known cams. The radii of the flange at the transition between the outer contour of the cam and its faces can be shorter. The supporting surface of the outer contour will accordingly be larger than those of conventional cams. The cam can accordingly be thinner, conserving considerable material and eliminating more weight. Radii shorter than 1 mm and preferably of 0.2 to 0.5 mm can be attained.

It has always been assumed that the width of the joint, which equals the width of the cam, must be as extensive as possible in order to attain the requisite high strengths. Widths of 10 mm or more have been employed. Experience has demonstrated, however, that widths of less than 6 mm and preferably of 3 to 5 mm can be successfully employed with the innovative cams specified herein.

Another advantage of such cams is that they are essentially easier to heat-treat than known embodiments, especially when, as recited in Claim 9, a bushing is accommodated between the cam and the core as a point of departure for hardening the overall cam if it is not already of a naturally hard and wear-resistant material. This combination of features prevents very hard cams from working into the core during operation and accordingly impairing the strength of the core or loosening the hold between the cam and the core.

The present invention will now be specified with reference to the accompanying drawing, wherein

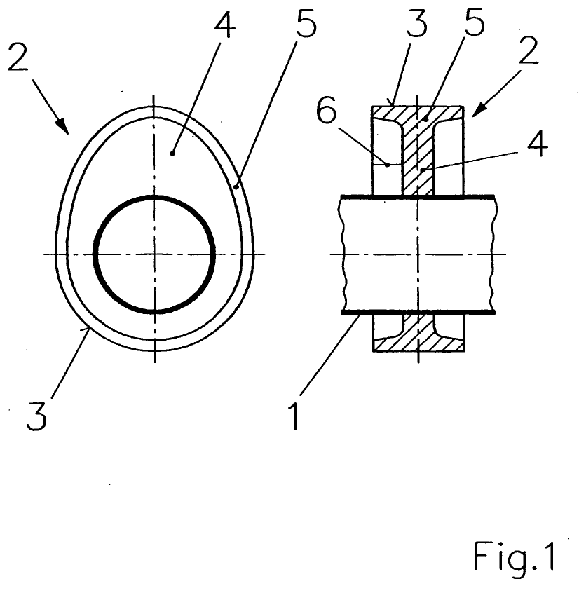

FIG. 1 is a view of and a cross-section through the vicinity of a cam mounted on a camshaft,

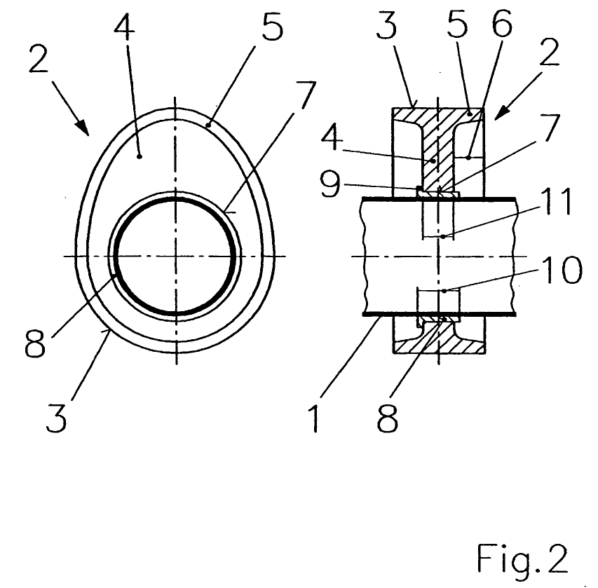

FIG. 2 is a similar representation of another embodiment,

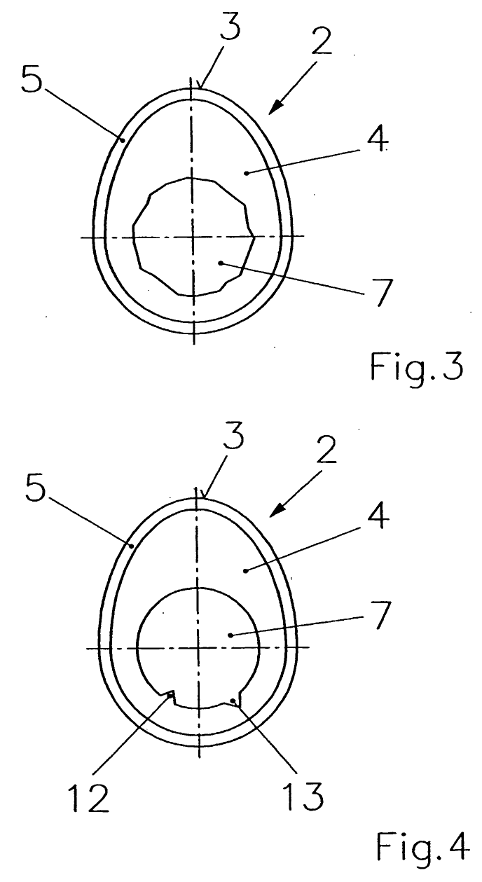

FIG. 3 illustrates a cam with an irregular core passage,

FIG. 4 illustrates a cam as in FIG. 3 [sic].

The core 1 of the camshaft illustrated in FIG. 1 is a hollow shaft. Several cams 2 of identical or different design are distributed along the surface of the core to comprise the finished camshaft. Although the contour 3 of each cam 2 can vary with the particular application, the contour of the cam in the illustrated embodiment is more or less oval. Each cam 2 is provided with a web 4 that extends in to the cam's center and merges outward into a flange 5. Flange 5 extends beyond web 4 to about the same extent 6 on each side. The cross-section of the flange is constant all the way around. The two projecting areas of the flange in the embodiment illustrated in FIG. 1 taper in, the inner surface of the projecting areas being in the form of the frustum of a cone. Flange 5 also merges into web 4 by way of a rounded transition.

Cams 2 can be fastened to core 1 by any known means.

Core 1 can for instance be rippled, with the diameter of a ripple exceeding the inner diameter of a cam 2, which can then be forced over the ripple, displacing material, and accordingly fastened tight.

Core 1 can alternatively be drummed or knurled in the vicinity of a cam 2. In this event, web 4 will be between 3 and 5 mm thick.

It is also possible to force a cam 2 onto a core 1 by expanding the cam's seat thereon. The core can for example be expanded by hydroforming before or after the cam has been positioned.

Finally, a cam 2 can be welded to core 1, preferably by laser welding.

Cams 2 mounted directly on a core 1 as illustrated in FIG. 1, are preferably hardened only at the outer surface of flange 5, at contour 3 in other words. The material should be hardened to a depth of 0.3 to 2 mm.

When the cams are through-hardened or produced from a naturally hard and highly wear-resistant material, the method of fastening illustrated in FIG. 2 can be employed. Here, the core passage 7 is slightly wider than the outside diameter of core 1. A bushing 8, preferably of a softer material, is inserted between core passage 7 and core 1. Assembly can be facilitated by providing bushing 8 with a flange 9, by way of which bushing 8 rests against web 4. Bushing 8 will preferably have a width 10 greater than the width 11 of web 4. This feature will improve the tightness of the joint without increasing pressure. Such a bushing will also considerably decrease chamfering between web 4 and core 1.

Cams 2 can be fabricated as desired by hot or cold forging from a ring or round blank. When, as specified in the foregoing and recited in the claims in conjunction with forged cams, this overall expression is intended to mean deformation of the material or blank by force and by way of tool parts that move toward each other. This can be done hot or cold, depending on the requirements of the particular material.

In special cases, however, the cams can also be fabricated by casting. Even powder-metallurgical fabrication by sintering may be of advantage, especially if the cams are to be of a high-strength and low-friction material. As a further alternative, flange 5 and web 4 can be separately fabricated, in which event the components can be of different materials and fastened together by forging into an individual cam 2.

Bushing 8 can to advantage be fabricated from sheetmetal by punching, stamping, or deep-drawing. It can also be bent round out of structural section, automatically ensuring tolerance between the diameter of bushing 8 and that of core 1.

When, as an alternative or supplement to the tight fastening approach hereintofore specified, an interlocking method of fastening the cams to the core is desired to prevent the cams from sliding around the core, the core passage 7 through cam 2 can have an irregular contour as illustrated in FIG. 3, This feature is of particular advantage when the cam is fastened to the core by hydroforming.

Still other alternatives are illustrated in FIG. 4. Here, either a ridge 12 extends out of web 4 and into a matching groove in core 1 or a ridge 13 extends out of the core and into a matching groove in the cam. Finally, the two components can be completely cogged. Such strategies are particularly appropriate when a cam is thrust axially over a structured section of the core.

1. Single-component cam (2) for a compound engine camshaft or valve-control camshaft, characterized by a half cross-section in the form of a T with a narrow web (4) extending toward the center and a surrounding flange (5) with a more or less constant cross-section projecting more or less evenly to each side.

2. Cam (2) as in claim 1, wherein the transition between the flange (5) and the web (4) is rounded.

3. Cam (2) as in claim 1, wherein the two projecting areas of the flange (5) taper out toward the web 4.

4. Cam (2) as in claim 1, characterized in that the flange (5) is entirely or peripherally harder than the web (4).

5. Cam (2) as in claim 1, characterized in that it is either entirely hardened or made of a naturally hard and wear-resistant material.

6. Cam (2) as in claim 1, characterized by a round cross-section core passage (7).

7. Cam (2) as in claim 1, characterized by an irregular cross-section core passage (7).

8. Cam (2) as in claim 6, wherein the core passage (7) is provided with one or more ridges or grooves with a rectangular or triangular cross-section.

9. Cam (2) as in claim 1, characterized in that the core passage (7) is wider than the core (1) and by a bushing (8) in the gap between them.

10. Cam (2) as in claim 9, wherein the bushing (8) is wider than the width (11) of the web (4).

11. Cam (2) as in claim 9, wherein the bushing (8) has a lateral flange (9).

12. Cam (2) as in claim 9, characterized in that bushing (8) is pressed out of sheetmetal.

13. Cam (2) as in claim 9, characterized in that the bushing (8) is provided with a longitudinal joint.

14. Cam (2) as in claim 1, characterized in that the flange (5) and the web (4) are fabricated separately and welded together to form a single component.

15. Mehod of manufacturing a cam (2) as in claim 1, more of claims 1 through 14, characterized in that the cam is hot or cold forged from pipe or from a blank.

16. Method for assembling an engine camshaft or valve control camshaft comprising a core and at least one cam (2) as in claims 1 characterized in that the core is drummed, rolled, or knurled to render the cams' seats wider than the inside of the cam, subsequent to which the cams are thrust along the core to produce a tight or interlocking fit between the cams and the core in the vicinity of the seats.
